(19) United States
(12) Patent Application Publication
(10) Pub. No.: US 2003/0123330 A1
(43) Pub. Date: Jul. 3, 2003

(54) Event timer having an adaptive interval for toilet training for children

(76) Inventors: Susie L. Carter, Paramount, CA (US); Dwayne S. Carter, Paramount, CA (US)

Correspondence Address: Tope-McKay & Associates, 23852 Pacific Coast Highway #311, Malibu, CA, 90265, US

(21) Appl. No.: 10/040,211

(22) Filed: Jan. 2, 2002

(51) Int. Cl. G04F 8/00; G04F 10/00

(52) U.S. Cl. 368/109

(57) ABSTRACT

An event timer having an adaptable interval for potty training for children is presented, comprising an adaptable timer for cumulatively adapting timing intervals to the needs of a particular child in response to input of potty training events. The event timer includes an input with buttons for providing user input to the adaptable timer indicating the occurrence of a potty training event. An output is connected with the adaptable timer for signaling the expiration of a timing interval, whereby the user input is used by the timer to adjust timing intervals based on the frequency of the occurrence of the event to more closely approximate the frequency of the occurrence of the event. The event timer is preferably in the form of a watch. A time period is divided into partitions, which serve as bins for cumulatively averaging the occurrence of timing events to develop timing intervals.

### BACKGROUND

(1) Technical Field

The present invention relates to controllable timing devices for signaling a predetermined event, and more particularly, to a timing apparatus for improving the effectiveness of children's potty training.

(2) Discussion

The toilet training process presents a difficult and challenging experience for both parents and children. This process consists of several stages that have been extensively studied. Training includes parental instruction and encouragement that the child should use a toilet, instead of diapers. The parents' goal in the training process is to properly teach the child to use the toilet within as little time as possible while making the experience positive and fun. While it is desirable to reduce the training time as much as possible during toilet training, the instruction requires a great deal of patience on the part of parents because children react very individually to the training.

A variety of devices aimed at encouraging children to use the toilet at proper times have been disclosed in the prior art. Some devices include an electrical circuit means that emits music or buzzes upon successful use of the toilet. For example, Minter teaches (U.S. Pat. No. 5,890,242) an electronic potty training apparatus with an audible reward system that is activated when a child hits a rotatable target with a urine stream in order to provide visual amusement and attract the child's attention. A number of other potty training devices utilize a music box mechanism for producing desired musical tones. U.S. Pat. No. 5,111,113 discloses a combination of a music box, lights and a control switch. Aiello (U.S. Pat. No. 5,518,405) teaches a battery-operated potty training device, wherein the musical device is in the form of an electrically motorized mechanism. While the inventions described above fulfill the purpose for which they are designed, in general, they are merely modifications and improvements of existing children's training devices, such as potty. None of these inventions disclose a timing mechanism that enables the estimation of the best time for using the toilet and encourages a child to do so.

The use of timing has existed for many years. Many designs of the timers and alarm mechanism have been disclosed in the art. Several examples from the art teach different variations of regular wristwatches and alarm clocks for use in timing. U.S. Pat. No. 6,259,655, for example, discloses a modified wristwatch with an adjustable indicator that allows an individual to tell at a glance at what point the individual is within the ultradian cycle. Rackley (U.S. Pat. No. 5,400,301) teaches a wristwatch alarm allowing a sick or handicapped person to set an alarm for indicating that medication should be taken. Similarly, U.S. Pat. No. 5,157,640 discloses a medication alert watch and system. Feignblatt, Jr. et al. (U.S. Pat. No. 4,591,836) teach a battery operated panic alarm wristwatch.

While fulfilling their particular goals and objectives, these inventions do not describe an event timer having an adaptive interval, which combines amusement and fun with informational value for parents and instructional value for children, most particularly, in the area of potty training into one simple device.

### SUMMARY

### BRIEF DESCRIPTION OF THE DRAWINGS

The novel features of the present invention are set forth in the appended claims. In order to better show the characteristics of the invention, the preferred embodiments are described hereafter, as examples without any limitative character. The features, aspects, and advantages of the present invention may be best understood in conjunction with the detailed description, with reference to the accompanying drawings where:

FIG. 1 is a block diagram depicting the functional components of the present invention;

FIG. 2 is a flow chart depicting the operations of the present invention; and

FIG. 3 is an illustrative diagram depicting the present invention in the preferred form of a watch.

### DETAILED DESCRIPTION

The present invention relates to the field event timer, and particularly to an event timer adapted children. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

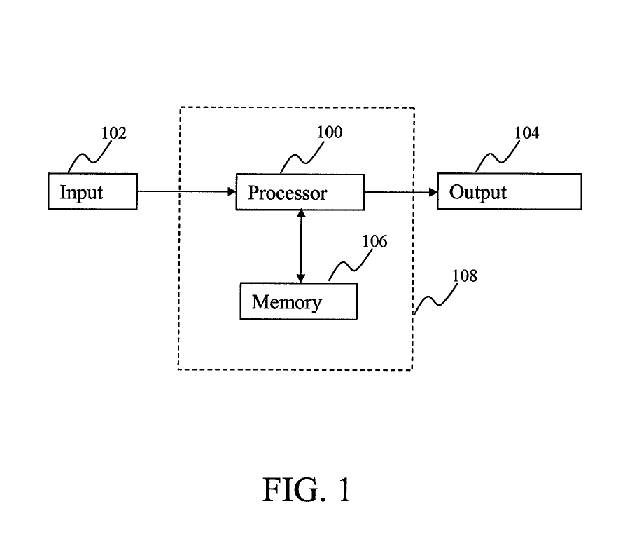

A block diagram is depicted in FIG. 1, showing the functional components of the event timer having an adaptable interval for potty training for children. As shown, the event timer includes a processor 100 for performing timing functions, for mapping input functions from an input 102, and for mapping output functions to an output 104. Additionally, a memory 106 is provided for storing user entered information regarding timing events. Generally, the input 102 includes at least one button to allow the user to provide information to the processor 100 in order to specify functions to be performed and to provide information regarding timing events for storage in the memory 106. The input 102 may also include the ability to receive vocal or other acoustic commands. The processor 100 and the memory 106 together comprise an adaptable timer 108.

The adaptable timer 108 includes an instruction set to allow for cumulatively adapting potty training timing intervals to the needs of a particular child in response to user input through the input 102. Although the present invention may be adapted for timing events other than those associated with potty training, it is geared toward potty training usage. The output 104 is used for signaling the expiration of a timing interval. Specifically, the end of a timing interval generally indicates that it is time for a child to attempt to go to the bathroom, at which point a combination of audio and visual output is generated for the child as a reminder, reward, and educational tool to assist in the potty training process. In particular, the adaptable nature of the present invention allows it to optimally adapt to the potty training needs of a particular child.

The adaptable timer 108 is operative for dividing a period of time, preferably a 24 hour period, into a plurality of partitions. Each partition is divided into a plurality of timing intervals. The length of the timing intervals within a partition is determined by dividing the length of the partition by the average number of occurrences of the potty training event during that partition. Each occurrence of a potty training event is entered into the event timer via the input 102, typically by the child or the child's parent. The average number of occurrences may be determined over many passages of the particular partition (over multiple periods of time—preferably multiple 24 hour periods), and the calculation of the average may be weighted so that more recent entries carry more weight in order to cause the average to be skewed toward the present time. On the other hand, the average may be over a user-specified or a pre-specified time interval, for example over the latest two week period. The period of time and the partitions may also be user-specified. By averaging the occurrence of events over a moderate amount of time, such as a two week period, the event timer is able to adapt to the current potty habits of a child, while still eliminating unusual spikes in potty activity through averaging.

As a narrative example to assist in a better understanding of the interrelationship of the period of time, the partitions, and the timing events, consider a case where the period of time is set to 24 hours and the 24 hour period of time is divided into eight 3-hour partitions, each of which serves as a “bin” for receiving user input representing the occurrence of events. The division of the time period into partitions for averaging purposes is intended to assist in generating a more accurate model of a child's potty habits. In this example, if the child tends to use the bathroom most frequently during hours 0 to 3 and hours 15 to 18, by partitioning the time into three hour intervals, a higher average of occurrences is recorded during hours 0 to 3 and hours 15 to 18, resulting in greater model accuracy than would be achieved by simply averaging the child's bathroom usage over the whole 24 hour period. The partitions may be adjusted as desired to facilitate the creation and optimization of the model of a child's potty habits. Also, because a child's bathroom habits change over time, it is desirable to average the potty training event occurrences over a recent time period, or to weight the occurrences so that the average is skewed toward the present. As stated previously, this ensures that the timer is adapted to the current habits of the child while eliminating unusual spikes through the use of averaging.

By default, the event timer may include a default set of timing data (timing intervals) derived from statistical averages regarding potty habits of children of varying ages. The event timer may use this timing data as a starting point for adapting to the habits of a particular child.

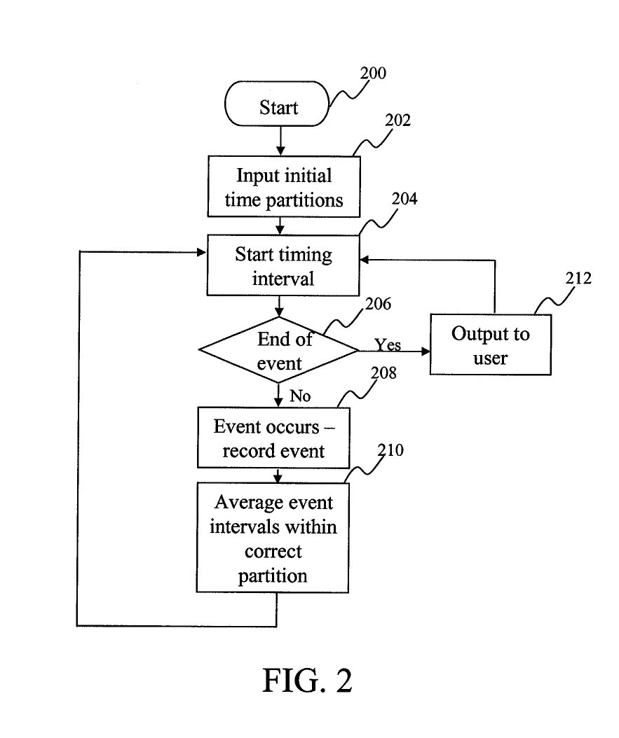

A flow chart depicting the operations of the present invention is presented in FIG. 2. A starting block 200 is provided to indicate the start of the routine. After the start, the user may input the initial time period and the initial time partitions 202. Note that the user for this purpose is usually a parent of the child. After the initial time period and the initial time partitions are entered, the timing interval can start 204. The timing interval may be started automatically after the initial time period and the initial time partitions have been inputted or it may start in response to a specific user input. If there no interval has been entered (either explicitly or if none exists as an initial condition) 206, nothing happens until the occurrence of an event. Upon the occurrence of an event, a user provides input through the input 102 of the event timer 208 to record the event for averaging within the current partition. The event timer then performs an averaging operation to update the timing intervals for the current partition 210. After the new average is derived and stored in the memory 106, a new timing interval starts 204. If, on the other hand, the end of a timing interval occurs 206, the event timer provides output to the user 212 to signal the end of the timing interval and that it is time for the child to go to the bathroom. The output may be in a visual or audio form or a combination of both. Non-limiting examples of the output include flashing lights, an LCD display, beeps, music, mechanical motions such as vibrations, speech (potentially related to the potty activity to be performed or in the form of short stories), animal sounds, sing-along songs, or a combination thereof.

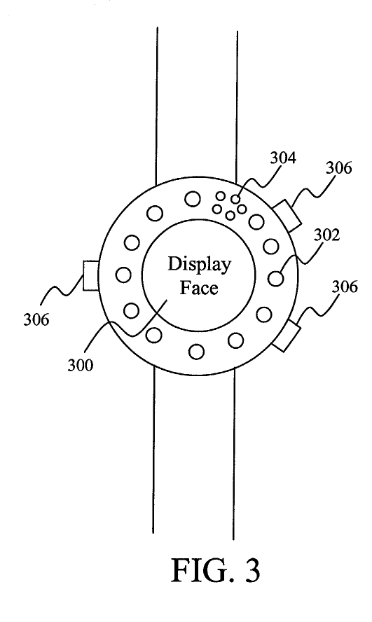

The processor 100 of the event timer preferably also performs a clock function with the output of the clock displayed by the output 104 of the event timer (in either digital or analog form). Preferably, the event timer is in the form of a clock such as the watch embodiment depicted in FIG. 3. The most preferable watch embodiment includes a watch face 300 for displaying the output of the clock (the time) and the timing information related to the functioning of the event timer, with motion lights 302 surrounding the watch face 300 and a speaker and/or microphone 304 to allow for acoustic input and output. Buttons 306 are provided about the perimeter of the watch in order to facilitate user input. The motion lights 302 strobe on and off in a predetermined order upon the expiration of a timing interval. Also, the speaker 304 sounds in response to the expiration of a timing interval to provide output to a user. The sounds from the speaker 304 may be in the form of vocal feedback, which may have a secondary effect of assisting a child in learning speech. Sounds may also be provided through the input 102 of the event timer in the form of a media card or cartridge such as a flash memory.

In addition to a watch, the event timer may also include various forms of attachment to a user such as a clip for attachment to a child's clothing, a belt for strapping the event timer around a child's waist, a strap for attaching the event timer around the neck of a child as a necklace. The event timer may also incorporate a sticky attachment mechanism such as an adhesive tape or Velcro to enable attachment to a toilet, wall, or other surface. The event timer may also be constructed in a variety of shapes such as the shape of a doll, an animal, a phone, or a vehicle, and may be waterproof to prevent mishaps from ruining the event timer's electronics while in the bathroom. In addition, the event timer may be made in a form to allow for incorporation into the seat of a toilet. The present invention can be used to assist in scheduling bathroom breaks in daycare centers or other facilities.

What is claimed is:

1. An event timer having an adaptable interval for potty training for children comprising:
a. an adaptable timer for cumulatively adapting timing intervals to the timing needs of a particular event type in response to user input;
b. an input including at least one button coupled with the adaptable timer for providing user input to the adaptable timer indicating the occurrence of an event;
c. an output connected with the adaptable timer for signaling the expiration of a timing interval, whereby the user input is used by the timer to adjust timing intervals based on the frequency of the occurrence of the event to more closely approximate the frequency of the occurrence of the event.

2. An event timer having an adaptable interval for potty training for children as set forth in claim 1, wherein the event timer further comprises a clock having a display for showing the time.

3. An event timer having an adaptable interval for potty training for children as set forth in claim 2, wherein the event timer is in a form selected from the group consisting of a watch, a clock having a clip for attaching to clothing, a necklace, a belt, a doll, an animal, and a vehicle.

4. An event timer having an adaptable interval for potty training for children as set forth in claim 3, wherein the output of the event timer comprises a plurality of motion lights that strobe on and off in a predetermined order in response to the expiration of a timing interval.

5. An event timer having an adaptable interval for potty training for children as set forth in claim 4, wherein the output of the event timer comprises a speaker that sounds in response to the expiration of a timing interval.

6. An event timer having an adaptable interval for potty training for children as set forth in claim 5, wherein the input of the event timer is adapted for receiving sound cartridges to provide interchangeable sounds for output through the speaker in response to the expiration of a timing interval.

7. An event timer having an adaptable interval for potty training for children as set forth in claim 6, wherein the adaptable timer includes preset timing intervals adapted for assisting in child potty training.

8. An event timer having an adaptable interval for potty training for children as set forth in claim 1, wherein the adaptable timer is operative for dividing a period of time into partitions, and where each partition is divided into timing intervals by dividing the partition time length by the average number of events occurring during the periodic passing of the partition.

9. An event timer having an adaptable interval for potty training for children as set forth in claim 2, wherein the period of time and the partitions are determined by user input.

10. An event timer having an adaptable interval for potty training for children as set forth in claim 9, wherein the event timer further comprises a clock having a display for showing the time.

11. An event timer having an adaptable interval for potty training for children as set forth in claim 10, wherein the event timer is in a form selected from the group consisting of a watch, a clock having a clip for attaching to clothing, a necklace, a belt, a doll, an animal, and a vehicle.

12. An event timer having an adaptable interval for potty training for children as set forth in claim 11, wherein the output of the event timer comprises a plurality of motion lights that strobe on and off in a predetermined order in response to the expiration of a timing interval.

13. An event timer having an adaptable interval for potty training for children as set forth in claim 12, wherein the output of the event timer comprises a speaker that sounds in response to the expiration of a timing interval.

14. An event timer having an adaptable interval for potty training for children as set forth in claim 13, wherein the input of the event timer is adapted for receiving sound cartridges to provide interchangeable sounds for output through the speaker in response to the expiration of a timing interval.

15. An event timer having an adaptable interval for potty training for children as set forth in claim 14, wherein the adaptable timer includes preset timing intervals adapted for assisting in child potty training.

16. An event timer having an adaptable interval for potty training for children as set forth in claim 8, wherein the period of time is a 24 hour interval, and wherein the partitions each consist of 3 hours, whereby as each 24 hour interval passes, each 3 hour partition is divided by the cumulative average number of occurrences of the event in that particular partition to determine the timing intervals for that partition.

17. An event timer having an adaptable interval for potty training for children as set forth in claim 16, wherein the cumulative average number of occurrences used for determining the timing intervals for that partition is weighted such that occurrences of the event during more recent occurrences of the partition are given greater weight in determining the timing intervals for that partition.

18. An event timer having an adaptable interval for potty training for children as set forth in claim 16, wherein the cumulative average number of event occurrences used for determining the timing intervals for each partition is a cumulative average number of occurrences of the event the over a user-selectable period, whereby a user may determine the time period over which the number of event occurrences is averaged in order to adjust the response of the adaptable timer to recent changes in the frequency of occurrence of an event.

19. An event timer having an adaptable interval for potty training for children as set forth in claim 18, wherein the event timer further comprises a clock having a display for showing the time.

20. An event timer having an adaptable interval for potty training for children as set forth in claim 19, wherein the event timer is in a form selected from the group consisting of a watch, a clock having a clip for attaching to clothing, a necklace, a belt, a doll, an animal, and a vehicle.

21. An event timer having an adaptable interval for potty training for children as set forth in claim 20, wherein the output of the event timer comprises a plurality of motion lights that strobe on and off in a predetermined order in response to the expiration of a timing interval.

22. An event timer having an adaptable interval for potty training for children as set forth in claim 21, wherein the output of the event timer comprises a speaker that sounds in response to the expiration of a timing interval.

23. An event timer having an adaptable interval for potty training for children as set forth in claim 22, wherein the input of the event timer is adapted for receiving sound cartridges to provide interchangeable sounds for output through the speaker in response to the expiration of a timing interval.

24. An event timer having an adaptable interval for potty training for children as set forth in claim 23, wherein the adaptable timer includes preset timing intervals adapted for assisting in child potty training.

25. An event timer having an adaptable interval for potty training for children as set forth in claim 16, wherein the cumulative average number of event occurrences used for determining the timing intervals for each partition is a cumulative average number of occurrences of the event the over a two-week period.

26. An event timer having an adaptable interval for potty training for children as set forth in claim 25, wherein the event timer further comprises a clock having a display for showing the time.

27. An event timer having an adaptable interval for potty training for children as set forth in claim 26, wherein the event timer is in a form selected from the group consisting of a watch, a clock having a clip for attaching to clothing, a necklace, a belt, a doll, an animal, and a vehicle.

28. An event timer having an adaptable interval for potty training for children as set forth in claim 27, wherein the output of the event timer comprises a plurality of motion lights that strobe on and off in a predetermined order in response to the expiration of a timing interval.

29. An event timer having an adaptable interval for potty training for children as set forth in claim 28, wherein the output of the event timer comprises a speaker that sounds in response to the expiration of a timing interval.

30. An event timer having an adaptable interval for potty training for children as set forth in claim 29, wherein the input of the event timer is adapted for receiving sound cartridges to provide interchangeable sounds for output through the speaker in response to the expiration of a timing interval.

31. An event timer having an adaptable interval for potty training for children as set forth in claim 30, wherein the adaptable timer includes preset timing intervals adapted for assisting in child potty training.
